(19) United States
(12) Patent Application Publication
(10) Pub. No.: US 2008/0023666 A1
(43) Pub. Date: Jan. 31, 2008

(54) Nano-Ionic Liquids and Methods of Use

(75) Inventor: Michael H. Gurin, Glenview, IL (US)

Correspondence Address: MICHAEL H. GURIN, 4132 COVE LANE, UNIT A, GLENVIEW, IL, 60025, US

(73) Assignee: Mr. Michael H. Gurin, Glenview, IL (US)

(21) Appl. No.: 11/309,025

(22) Filed: Jun. 12, 2006

Related U.S. Application Data
(60) Provisional application No. 60/595,167, filed on Jun. 13, 2005.

(51) Int. Cl. C09K 5/00

(52) U.S. Cl. 252/74; 252/71

(57) ABSTRACT

A high efficiency thermal energy conversion working fluid based in large part on hybrid ionic liquid solutions and its application within thermal energy conversion devices is disclosed. Using the preferred ionic liquid and carbon dioxide gas with partially miscible absorber fluids, including the preferred ionic liquids as the working fluid in the system. The thermal conversion device transforms thermal energy, including low quality, into heating, cooling, mechanical energy, or electricity. Strategic use of heat exchangers, preferably microchannel heat exchangers comprised of nanoscale powders can further increase the efficiency and performance of the system.

### CROSS-REFERENCE TO RELATED APPLICATIONS

This application claims priority from U.S. Provisional Patent Application Ser. No. 60/595,167 filed Jun. 13, 2005 having the tile “Nano-Ionic Liquids and Methods of Use” and is also a continuation-in-part of U.S. patent application Ser. No. 60/593,485 filed Jan. 18, 2005, having the title “High Efficiency Absorption Heat Pump and Methods of Use” and included as reference only without priority claims.

### FIELD OF THE INVENTION

The invention is directed generally to synergistic blends of ionic liquids and a range of additives including electrides, alkalides, and nanoscale surface modified particles for applications including energy conversion and transformation.

### DESCRIPTION OF RELATED ART

Heat pumps are well known in the art. A heat pump is simply a device for delivering heat or cooling to a system, whereas a refrigerator is a device for removing heat from a system. Thus, a refrigerator may be considered a type of heat pump. Throughout the application, the invention will be referred to as a thermal energy transformation device, hereinafter referred to as “TED” with the understanding that the designation of refrigerator, air conditioner, compressor, water heater, trigeneration, and cogeneration could be substituted without changing the operation of the device, specifically TEDs that utilize supercritical and transcritical fluids.

Thermionics emission and thermovoltaic cell are well known in the art. A thermionics emission or thermovoltaic cell is simply a device without moving parts for transforming heat to electricity. Throughout the application, the invention will be referred to as a cell with the understanding that the designation of any device that involves phonon-to-electron coupling could be substituted without changing the operation of the device.

In absorption heat pumps, an absorbent such as water absorbs the refrigerant, typically ammonia, thus generating heat. When the combined solution is pressurized and heated further, the refrigerant is expelled. When the refrigerant is pre-cooled and expanded to a low pressure, it provides cooling. The low pressure refrigerant is then combined with the low pressure depleted solution to complete the cycle.

Many current absorption heat pump/refrigerators make use of either a water-ammonia couple, or a water-lithium bromide. These two absorption couples suffer from certain drawbacks. The water-ammonia couple raises security problems in view of the toxicity and flammability of ammonia, and LiBr is corrosive and very failure prone due to low pressure operation, i.e., small leaks create contamination. Moreover, the tendency to crystallize can be a clogging problem. Operating at very low pressures is often impossible due to the freezing of water. Other absorption processes have been proposed, but all involve working fluids that are toxic, flammable, ozone-depleting, or have high atmospheric green house effects.

U.S. Pat. No. 6,374,630 titled “Carbon dioxide absorption heat pump” by Jones is a traditional absorption cycle utilizing supercritical carbon dioxide. This patent does not anticipate an absorber having either a very low vapor pressure, a boiling point less than 50 .degree.C., nor any means to achieve a coefficient of performance better than 0.70. This patent further does not anticipate any non-thermal means to reduce desorption temperature, nor the extraction of expansion energy.

U.S. patent application Ser. No. 20030182946 Sami et al., titled “Method and apparatus for using magnetic fields for enhancing heat pump and refrigeration equipment performance” utilizes a magnetic field is operable to disrupt intermolecular forces and weaken intermolecular attraction to enhance expansion of the working fluid to the vapor phase. Magnetic field energy has been found to alter the polarity of refrigerant molecules and disrupt intermolecular Van der Waals dispersion forces between refrigerant molecules, though does not anticipate the utilization of a magnetic field to reduce desorption energy.

U.S. Pat. No. 6,434,955 titled “Electro-adsorption chiller: a miniaturized cooling cycle with applications from microelectronics to conventional air-conditioning” by Ng, et al. presents the combination of an absorption and thermoelectric cooling devices. The governing physical processes are primarily surface rather than bulk effects, or involve electron rather than fluid flow. This patent does not anticipate a continuous absorption process, but rather the transfer of thermal energy from a batch desorption process into the sequentially processed batch for subsequent desorption.

U.S. patent application Ser. No. 20030221438 titled “Energy efficient sorption processes and systems” by Rane, Milind V., et al. devises adsorption modules with heat transfer passages in thermal contact with the adsorption module wall and switchable heat pipes, adsorption module of this invention leads to lower cycle times as low as 5 minutes, efficient multi-stage regeneration processes, for regenerating liquid desiccant using rotating contacting disks. This patent does not anticipate either a continuous process nor an absorption process.

U.S. patent application Ser. No. 20020078696, titled “Hybrid heat pump” and U.S. Pat. No. 6,539,728 titled “Hybrid heat pump”, both by Korin, is a hybrid heat pump system that includes (i) a membrane permeator having a permselective membrane capable of selectively removing vapor from a vapor-containing gas to yield a dry gas, (ii) a heat pump having (a) an internal side for exchanging thermal energy with a process fluid, (b) an external side for exchanging thermal energy with an external environment, and (c) a thermodynamic mechanism for pumping thermal energy between the internal side and the external side in either direction. Korin differs significantly by the use of membranes to pre-condition air in conjunction with a refrigeration air conditioning system, and not to perform any phase separation within the refrigerant itself. Furthermore, although membranes have been used in various separation applications, their use for heat pump systems has been limited. U.S. Pat. Nos. 4,152,901 and 5,873,260 propose to improve an absorption heat pump by using of semipermeable membrane and pervaporation membrane respectively. U.S. Pat. No. 4,467,621 proposes to improve vacuum refrigeration by using sintered metal porous membrane, and U.S. Pat. No. 5,946,931 describes a cooling evaporative apparatus using a microporous PTFE membrane. These patents do not anticipate the use of membranes for phase separation within absorption system, but rather adsorption systems.

U.S. Pat. No. 4,152,901 by Munters is a method and apparatus for transferring energy in an absorption heating and cooling system where the absorbent is separated from the working medium by diffusing the mixture under pressure through a semi-permeable membrane defining a zone of relatively high pressure and a zone of relatively low pressure higher than the ambient pressure. Munters does not anticipate supercritical operation, as it explicitly states that the “dilute solution of working medium is passed to the evaporator upon being depressurized, while the concentrated absorbent solution, upon being reduced to the ambient pressure, is passed into the sorption station”.

U.S. Pat. No. 5,873,260 titled “Refrigeration apparatus and method” by Linhardt, et al. utilizes the pressure of absorbent/refrigerant solution is increased and the pressurized solution is supplied to a pervaporation membrane separator which provides as one output stream a vapor-rich refrigerant and as another output stream a concentrated liquid absorbent. Linhardt et al. do not anticipate supercritical fluids as explicitly stated “the pressure of the substantially vaporized refrigerant input to the absorber is less than 50 psia” and “the pressure of the absorbent/refrigerant solution entering the membrane separator is within the range of about 250 to 400 psia.” Linhardt further notes that “Osmotic-membrane-absorption refrigeration cycles are also capable of reaching low temperatures and may have a COP higher than conventional ammonia/water heat-separation systems, but require very high pressures, of the order of 2,000 psia or more to force the refrigerant through the pores of the osmotic membrane.” It is to be noted that a pervaporation membrane operates in a totally different fashion from the prior art membrane separation processes used in refrigeration and heat pump systems. Such prior art membrane systems rely on osmotic pressure to force the refrigerant through the membrane thereby separating the refrigerant from other constituents. For the ammonia-water pair, this conventionally requires pressures of the order of magnitude of 2,000 to 4,000 PSI and higher. Osmotic membranes are porous which allows the ammonia to pass through the membrane. Pervaporation membranes are not porous, but pass constituents through the membrane by dissolving the selected material into the membrane. This allows a much lower driving force, significantly less than 400 PSI, to act as the driver. In the case of an ammonia-water mixture, the pervaporation membrane, selectively passes ammonia and water vapor and rejects liquid water.

U.S. Pat. No. 6,739,142 titled “Membrane desiccation heat pump” by Korin is a system includes (a) a membrane permeator for removing vapor from a process gas and for providing a vapor-depleted process. This patent does not disclose the use of any supercritical fluids.

The art lacks a high efficiency heat transfer solution, hereinafter referred to as ionic liquid hybrid solutions or “ILHS” that achieves within any TED system with a coefficient of performance greater than TEDs without ILHS.

### BRIEF DESCRIPTION OF THE DRAWINGS

FIG. 1—A graphical view depicting an exemplary ionic liquid 1-n-butyl-3-methylimidazolium hexafluorophosphate ([bmim][PF.sub.6]) absorption measurements of carbon dioxide.

### SUMMARY OF THE INVENTION

The present invention is an ionic liquid hybrid solution utilized within thermal energy transformation devices. The devices use a solution comprised of ionic liquids that is an effective thermal transport media.

The inventive ILHS operating within a TED is now set forth as an optimal media to achieve energy transformation using thermal means.

The inventive ILHS utilizes a range of fluids selected from the group consisting of ionic liquids, ionic solids, electride solutions, alkalide solutions, and supercritical fluids/gases. Ionic liquids and solids are recognized in the art of environmentally friendly solvents. Electride and alkalide solutions are recognized in the art of chemical reduction methods and oxidation methods respectively. TEDs uniquely feature ionic liquids “ILs”, which have very low if not negligible vapor pressure, preferably ionic liquids compatible with supercritical gases, hereinafter referred to as “scG”s, preferably carbon dioxide or ammonia, respectively “scCO2” or “scNH4”. The inventive combination of scCO2 or scNH4 and ILs have excellent carbon dioxide solubility and simple phase separation due to their classification as partially miscible fluid combinations. Partially miscible fluids are both miscible and immiscible as a direct function of both pressure and temperature. A partially miscible fluid in its immiscible state can be simply decanted for phase separation, which is inherently a low energy separation method. The phase behavior of scGs with ionic liquids and how the solubility of the gas in the liquid is influenced by the choice and structure of the cation and the anion.

Additional combinations of ionic liquid solutions are recognized in the art as having partial miscibility. A further aspect of the invention is the achievement of phase separation as a function of at least one function selected from the group consisting of temperature, pressure, and pH. The preferred solution further includes the utilization of small amounts of acids or bases to vary solubility of the refrigerant within absorber. The more preferred solution varies temperature and pressure, in combination pH control using methods including electrodialysis. Additional methods to enable phase separation include the application of electrostatic fields for purposes including the electrostatic field's ability to increase solubility of ionic fluids, and ultrafiltration or nanofiltration membranes.

The inventive ILHS further leverage electride and alkalide solutions. The preferred electride solution is comprised of anhydrous ammonia. The principal benefit of electrides is centered around the transfer of free electrons (i.e., energy state) between the cathode and anode. An additional benefit, which is essential to the later incorporation of nanoscale powders, is the electride's strong reducing characteristics. This is essential as nanoscale powders, specifically metals, readily oxidize due in part to the powder's high surface area.

Yet another feature of the invention is the further inclusion of at least one nanoscale powder selected from of the group consisting of conductive, semi-conductive, ferroelectric, and ferromagnetic powders. Nanoscale powders, as recognized in the art, maintain colloidal dispersions while enhancing or varying a range of properties including magnetism, thermophysical properties (e.g., thermal conductivity), electrical conductivity, and absorption characteristics. The more preferred nanoscale powders are further comprised of nanoscale powders having nanoscale surface modifications, including surface modifications selected from the group of monolayer, and nanoscale multi-layers (i.e., surface coatings of less than 100 nanometers). The specifically preferred nanoscale powders enhance more than one parameter selected from the group consisting of thermophysical properties, electrical conductivity, and solar light spectrum absorption.

A yet further feature of the inventive ILHS are the integration of TEDs. The thermal energy extraction devices enhance efficiency (i.e., coefficient of performance “COP”) by extracting energy during the expansion stage of the refrigerant following the desorption step, or by the direct quantum conversion of phonons to electrons.

Ionic liquids have the distinct advantages of relatively higher electrical conductivity (i.e., electron transport) with a corresponding lower thermal conductivity as compared to traditional heat transfer fluids. These characteristics are desirable as known in the art of converting thermal energy to either mechanical or electrical energy. Such devices include thermal energy conversion devices. TEDs include devices selected from the group consisting of thermionics emission cell, thermovoltaic cell, electricity generator, compressor, and heat pump. The preferred ILs are in a solution that is further comprised of fluids including fluids recognized in the art as heat transfer fluids. The preferred ionic liquids are the inventive ionic liquid hybrid solutions “ILHS”. ILHS' are solutions that include at least one heat transfer fluid wherein at least one parameter selected from the group consisting of pressure and temperature is altered wherein the heat transfer fluid and ionic liquid are partially miscible or miscible. A readily ILHS that has regions in which at least one individual fluid component becomes immiscible enables relatively simple fluid separation. Regions in which the fluids are at least partially miscible or completely miscible enable the fluids to undergo the heat of absorption, which provides the ability to efficiently remove this energy (i.e., through condenser).

The further incorporation of surface modified nanoscale particles having an average particle size of from 0.1 nm to 1000 nm enables the combination of either/both increased electrical and/or thermal conductivity respectively. Without being bound by theory, it is believed that nanoscale particles of this invention have increased mean free path length of electron emission by incorporating the surface modified particles. The preferred nanoscale particles are both semiconductive and conductive particles. The preferred ILHS is further comprised of at least one solution selected from the group consisting of electrides, or alkalides. The preferred electride or alkalide, as recognized in the art, is a room temperature stable electride or alkalide.

The ILHS can be further utilized for the reduction or oxidation of nanoscale particles. The preferred scenario restricts the agglomeration of resulting particles to achieve small nanoscale particles. The particularly preferred method to reduce the resulting particle size is for such reduction/oxidation reaction to take place within a series of physically constrained “reaction” cells that constrain the resulting products within a small size. The specifically preferred reaction cells are within a size approximately between 0.1 nm and 1000 nm.

The resultant products from the subsequent chemical reduction or oxidation of nanoscale particles are also between 0.1 nm and 1000 nm. The best way to achieve this is to start with precursor nanoscale particles that are also between 0.1 nm and 1000 nm. The preferred nanoscale particles are of substantially spherical nanoscale particles. The particularly preferred nanoscale particles are surface modified (e.g., copper with benzotriazole). The specifically preferred nanoscale particles are less than 100 nm, and further preferably less than 10 nm. The particularly preferred nanoscale particles are both less than 10 nm and monodisperse. Without being bound by theory, the surface modified particles (including by complexation) have less agglomeration, increased adhesion between multiple layers, and higher mean free path of electron/phonon tunneling and/or coupling. The specifically preferred nanoscale particles are surface modified by complexation and are of substantially the same diameter. Particles utilized within TEDs, most notably thermionics cells, have diameters less than 10 nm. Without being bound by theory, it is recognized that electrons can tunnel through a distance of 10 nm whereas phonons cannot. The incorporation of 10 nm (or less) spherical diameter nanoscale particles within a vacated thermionics cell enables the hot and cold side of the thermionics cell to be consistently and uniformly spaced.

The incorporation of semi-conductive nanoscale particles, without being bound by theory, has the potential to increase the mean free path length up to 35 nm. The critical distance between the hot and cold side of a thermionics cell thus has the ability for electrons to tunnel across with the cell space being separated by substantially spherical shape particles having diameters between an average of from 0.1 nm to 35 nm.

The combination of nanoscale particles comprised of at least one of electrically conductive or semi-conductive, and thermally conductive, without being bound by theory, has the ability to shift the desired balance to increase or decrease phonon to electron coupling. The more preferred composition is comprised of both electrically conductive and thermally non-conductive substantially spherical shape particles. The particularly preferred spherical shape particles are further comprised of multi-layer coatings consisting of alternating layers of at least one layer selected from the group consisting of electrically conductive and thermally non-conductive layers.

Each alternating layer has an average thickness of from 0.1 nm and 10 nm. The more preferred alternating layer has an average thickness of from 0.1 nm and 3 nm. The particularly preferred outermost alternating layer is not reactive with the ionic liquid solution. The specifically preferred outermost alternating layer is readily reduced as a means of chemical reduction of organometallic or metallic salts. One such method, though not limited to, is hydrogen reduction. Another method that is particularly good with ionic liquids is reduction by electroplating, wherein the organometallic or metallic salts is reduced by the voltage differential, however, the reduced metal is constrained within the layer(s) of “encapsulating” layers. One such encapsulating layer is readily polymerized as a means of constraining a subsequent chemical reduction of organometallic or metallic salts.

The ability to readily immobilize the inner contents (e.g., organometallic or metallic salts) of a multi-layer nanoscale particle also includes at least one alternating layer that is readily crosslinked as a means of chemical reduction of organometallic or metallic salts. Such alternating layer materials include, though not limited to monomers, proteins, and ultraviolet cured polyimides. The resulting polymerization process provides crosslinked polymers and polymerized monomers. The ionic liquid solution, which contains physically constrained nanoscale particles is designed to reduce metallic salts, organometallics, metal oxides, and metal nitrides by means selected from the group consisting of electrical reduction, chemical reduction, and photo reduction. An additional method of achieving nanoscale particles occurs by pre-processing the ILHS into a nanoemulsion, nano-colloidal suspension, or microemulsion. Processing into a nanoemulsion, nano-colloidal suspension, or microemulsion has additional benefits including, though not limited, by viscosity reduction, homogeneous dispersion, and a container-less physically constraining micelle.

The ILHS is further comprised of electrides or alkalides, without being bound by theory, to improve at least one from the group consisting of phonon-to-electron coupling, heat transfer, and thermal to electrical conversion. The preferred ILHS further contains a heat transfer fluid. The more preferred ILHS has a heat transfer fluid that is partially miscible or miscible with the ILHS or at least one additional fluid in the ILHS. A particularly preferred ILHS further includes a supercritical gas. The preferred gas includes gases selected from the group consisting of carbon dioxide, nitrogen, argon, and ammonia. The particularly preferred ILHS for the purpose of subsequent chemical reactions is ammonia. Ammonia is recognized in the art as being a significant component of electrides. The specifically preferred ILHS is a solution pressurized to at least the solution's supercritical pressure. The ILHS solution/blend operates at least the solution's supercritical pressure within a TED. The ILHS within the TED can also operate over the transcritical pressure region.

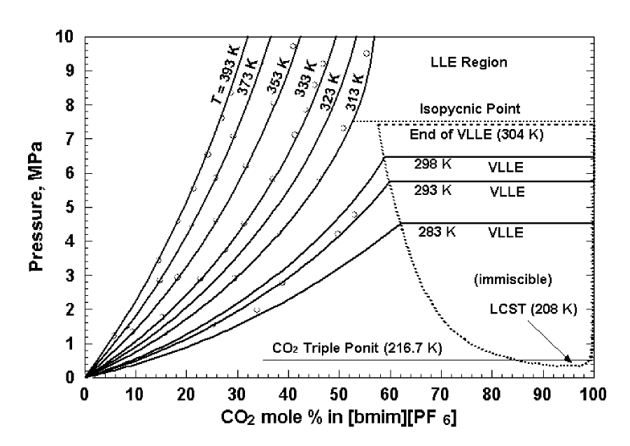

An exemplary ionic liquid family with supercritical carbon dioxide CO.sub.2 is depicted in FIG. 1 (as conducted by DuPont Central Research and Development, and DuPont Fluoroproducts Laboratory) in which absorption measurements of 1-n-butyl-3-methylimidazolium hexafluorophosphate ([bmim][PF.sub.6]) and 1-n-butyl-3-methylimidazolium tetrafluoroborate ([bmim] [BF.sub.6]) were made using a commercial gravimetric microbalance at temperatures of 283.15, 298.15, 323.15 and 348.15 K and at pressures under 2 MPa. Gas solubilities were determined from absorption saturation (equilibrium) data at each fixed temperature and pressure. The figure clearly demonstrates the significant pressure gains obtained by relatively small temperature differentials, and regions where immiscibility takes place.

The supercritical ILHS solution is further mixed with nanoscale precursors having an average particle size of from 0.1 nm to 1000 nm and immediately subjected to rapid expansion. The process of rapid expansion has numerous benefits, including the benefit of counteracting exothermic chemical reactions, and reducing particle agglomeration.

The supercritical ILHS solution undergoes at least one parametric change selected from the group consisting of pressure and temperature. The pressure and/or temperature are altered so that at least one component/fluid from within the ILHS group consisting of heat transfer fluid, ionic liquid, and supercritical fluid so that phase separation is readily achieved by leveraging regions whereby the ILHS is partially miscible or miscible and becomes immiscible.

The inventive ILHS is optimally designed/formulated to operate within an energy conversion device such as the noted TED. The TED is further comprised of at least one field including fields selected from the group consisting of electrical, electrostatic, and magnetic fields. The field increases heat transfer, without being bound by theory, due to at least one benefit selected from the group consisting of accelerating electrons, limiting phonon backscattering, or limiting cold electron backscattering. The TED is further comprised of a barrier film whereby the barrier film is between the thermal source and the ILHS. The barrier film is further comprised of components selected from the group consisting of diamond, diamond-like, metal, and carbon nanotubes, which without being bound by theory, reduces heat transfer and phonon tunneling across the gap of the TED between the hot and cold sides.

The cell, including thermionics cells, is further comprised of nanoscale particles characterized by at least one feature selected from the group consisting of substantially spherical shape and same diameter to separate the top and bottom cell sides. The top and bottom cell sides are separated by an average distance of from 0.1 nm and 100 nm. The top and bottom cell sides are more preferred separated by an average distance of from 0.1 nm and 35 nm. The top and bottom cell sides are particularly preferred separated by an average distance of from 0.1 nm and 10 nm.

The many benefits realized by the inventive ILHS solution and operation within the TED, the coefficient of performance within either a thermodynamic cycle or direct thermal to electrical conversion, including through phonon-to-electron coupling, is increased to increase energy efficiency. The preferred thermodynamic cycles in which the benefits will be realized include cycles selected from the group consisting of Goswami, Uehara, Kalina, Rankine, Carnot, Joule-Brayton, Ericsson, and Stirling cycles. The preferred cycles are combination cycles in which the ILHS converts waste heat from any single thermodynamic cycle into a hybrid high efficiency thermodynamic cycle.

The preferred utilization within the thermodynamic cycle is such that a transcritical or supercritical gas is absorbed at a relatively lower pressure and temperature. The supercritical ionic liquid/gas solution is subsequently elevated to either or both a higher pressure and temperature, at which the gas is desorbed and separated from the ionic liquid. The desorbed gas is expanded for at least one purpose including providing cooling and/or energy extraction (e.g., turbine, Stirling engine, etc.)

What is claimed is:

1. An ionic liquid solution whereby the solution operates within thermal energy conversion devices including devices selected from the group consisting of thermionics emission cell, thermovoltaic cell, electricity generator, compressor, and heat pump.

2. The solution according to claim 1 wherein the solution is further comprised of nanoscale particles characterized by at least one feature selected from the group consisting of substantially spherical shape and same diameter.

3. The solution according to claim 2 wherein the solution is within the cell comprised of a top and bottom cell side separated by an average distance of from 0.1 nm and 10 nm.

4. The solution according to claim 2 whereby the substantially spherical shape particles are at least one particle selected from the group consisting of electrically conductive or semi-conductive, and thermally conductive particles.

5. The ionic liquid solution according to claim 2 whereby the ionic liquid is further comprised of at least one heat transfer fluid wherein at least one parameter selected from the group consisting of pressure and temperature is altered and wherein the heat transfer fluid and ionic liquid are partially miscible or miscible.

6. The solution according to claim 2 whereby the substantially spherical shape particles are further comprised of multi-layer coatings consisting of alternating layers of at least one layer selected from the group consisting of electrically conductive and thermally non-conductive layers, wherein each alternating layer has an average thickness of from 0.1 nm and 10 nm.

7. The solution according to claim 1 whereby the energy conversion device is further comprised of at least one field including fields selected from the group consisting of electrical, electrostatic, and magnetic fields.

8. The solution according to claim 7 whereby the field increases heat transfer due to at least one benefit selected from the group consisting of accelerating electrons, limiting phonon backscattering, or limiting cold electron backscattering.

9. An ionic liquid and at least one absorbed gas selected from the group consisting of a transcritical or supercritical gas in solution whereby the subsequently desorbed gas is utilized within a thermodynamic cycle including cycles selected from the group consisting of Goswami, Uehara, Kalina, Rankine, Carnot, Joule-Brayton, Ericsson, and Stirling.

10. The ionic liquid solution according to claim 9 whereby the ionic liquid is further comprised of at least one heat transfer fluid wherein at least one parameter selected from the group consisting of pressure and temperature is altered and wherein the heat transfer fluid and ionic liquid are partially miscible or miscible.

11. An ionic liquid solution comprised of an ionic liquid and at least one solution selected from the group consisting of heat transfer fluid further comprised of nanoscale particles, electrides, alkalides, nanoscale particle precursors whereby the ionic liquid is physically constrained within a size approximately between 0.1 nm and 1000 nm for subsequent chemical reduction or oxidation of nanoscale particles, surface modified nanoscale particles having an average particle size of from 0.1 nm to 100 nm, substantially spherical nanoscale particles having an average monodisperse particle size of from 0.1 nm to 100 nm.

12. The solution according to claim 11 further comprised of a gas whereby the solution is pressurized to at least the solution's supercritical pressure.

13. The solution according to claim 11 whereby the nanoscale particle precursors are comprised of metallic salts, organometallics, metal oxides, and metal nitrides and are subsequently reduced by means selected from the group consisting of electrical reduction, chemical reduction, and photo reduction.

14. The solution according to claim 11 are further comprised of both semiconductive and conductive nanoscale particles.

15. The solution according to claim 11 wherein the nanoscale particles are of substantially the same diameter.

16. The solution according to claim 11 whereby the solution is subjected to rapid expansion.

17. The solution according to claim 11 whereby the solution increases the mean free path length of electron emission.

18. The solution according to claim 11 whereby the solution is further comprised of at least one nanoscale particle selected from the group consisting of nanoscale diamond, diamond-like, metal, carbon nanotubes, crosslinked polymers, or polymerized monomers.

19. The ionic liquid solution according to claim 11 whereby the ionic liquid is further comprised of at least one heat transfer fluid wherein at least one parameter selected from the group consisting of pressure and temperature is altered and wherein the heat transfer fluid and ionic liquid are partially miscible or miscible.

20. The solution according to claim 11 whereby the nanoscale particles are further comprised of multi-layer coatings consisting of alternating layers of at least one layer selected from the group consisting of electrically conductive and thermally non-conductive layers, wherein each alternating layer has an average thickness of from 0.1 nm and 10 nm.

21. The solution according to claim 20 whereby the alternating layers outermost alternating layer is not reactive with the ionic liquid solution.

22. The solution according to claim 20 whereby at least one of the alternating layers is readily reduced as a means of chemical reduction of organometallic or metallic salts.

23. The solution according to claim 20 whereby at least one of the alternating layers is readily polymerized as a means of constraining subsequent chemical reduction of organometallic or metallic salts.
